(19) United States
(12) Patent Application Publication
(10) Pub. No.: US 2015/0194142 A1
(43) Pub. Date: Jul. 9, 2015

(54) DEVICE AND METHOD OF USE FOR A DEER FEEDER SOUND ENHANCER

(71) Applicant: Kevin Roberts, Breckenridge, TX (US)

(72) Inventor: Kevin Roberts, Breckenridge, TX (US)

(21) Appl. No.: 14/588,933

(22) Filed: Jan. 3, 2015

Related U.S. Application Data
(60) Provisional application No. 61/923,481, filed on Jan. 3, 2014.

(51) Int. Cl. G10K 1/07; A01K 5/00; A01M 31/00

(52) U.S. Cl. CPC G10K 1/07; A01M 31/00; A01K 5/00

(57) ABSTRACT

Disclosed herein is a device and method of use directed to enhancing the sound of deer feeders. More specifically, the present invention generally relates to a device and method of use directed to enhancing the sound made by deer feeders when feed is being distributed for the increased attraction of deer. In one embodiment the device is comprised of a base element and an attachment element. In another embodiment, the base element is comprised of a square surface portion that functions to enhance the sound made by deer feeders when feed is being distributed. In yet another embodiment, the device is attached to the legs portion of the feeders at a height that allows the base element to be contacted by the deer feed as the deer feed is being distributed.

### CROSS-REFERENCE TO RELATED APPLICATIONS

This application claims the benefit under Title 35 United States Code §119(e) of U.S. Provisional Patent Application Ser. No. 61/923,481; Filed: Jan. 3, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a device and method of use directed to enhancing the sound of deer feeders. More specifically, the present invention generally relates to a device and method of use directed to enhancing the sound made by deer feeders when feed is being distributed for the increased attraction of deer.

### BACKGROUND OF THE INVENTION

Without limiting the scope of the disclosed device, the background is described in connection with a novel device and method of use to efficiently and effectively enhance the sound of feed being distributed by deer feeders to increase the attraction of deer.

Deer feeders are often used as a great addition to hunting grounds. They assist in making sure the deer are well fed for growth and size for the hunting season and assist in bringing the deer in as targets during hunting season. When deer feeders distribute the feed, the sound of the feed being distributed attracts the deer. For the common three and four leg deer feeder, the sound is mostly generated from the feed which is typically corn hitting against the legs of the deer feeder. This sound can be heard at a modest range and for those deer that hear the sound, they are attracted and feed at the location of the deer feeder.

One issue with existing feeders is that the sound can only be heard for a certain range. That is, their effectiveness is limited to the range that the feed being distributed can be heard by the deer. In addition, the wind can reduce the effectiveness of the deer feeder's attraction by mitigating the distance the deer feeder's feed distribution noise travels.

Therefore, the present invention proposes a novel device and method of use to efficiently and effectively amplify the sound of feed being distributed by deer feeders to increase the attraction of deer.

### BRIEF SUMMARY OF THE INVENTION

The present invention, therefore, provides for a device and method of use directed to amplifying the sound of feed being distributed by deer feeders to increase the attraction of deer.

In one embodiment the device is comprised of a base element and an attachment element. In another embodiment, the base element is comprised of a square surface portion that functions to enhance the sound made by deer feeders when feed is being distributed. In yet another embodiment, the device is attached to the legs portion of the feeders at a height that allows the base element to be contacted by the deer feed as the deer feed is being distributed.

In summary, the present invention discloses a device and method of use directed to enhancing the sound of feed being distributed by deer feeders to increase the attraction of deer.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a back side exploded perspective view of the deer feeder sound enhancer device in accordance with embodiments of the disclosure;

FIG. 2 is a front side perspective view of the deer feeder sound enhancer device in accordance with embodiments of the disclosure;

FIG. 3 is a front side view of the deer feeder sound enhancer device in accordance with embodiments of the disclosure;

FIG. 4 is a back side view of the deer feeder sound enhancer device in accordance with embodiments of the disclosure;

FIG. 5 is a bottom side view of the deer feeder sound enhancer device in accordance with embodiments of the disclosure;

FIG. 6 is a top side view of the deer feeder sound enhancer device in accordance with embodiments of the disclosure;

FIG. 7 is a left side view of the deer feeder sound enhancer device in accordance with embodiments of the disclosure;

FIG. 8 is a right side view of the deer feeder sound enhancer device in accordance with embodiments of the disclosure;

FIG. 9 is an environmental front side perspective view of the deer feeder sound enhancer device in accordance with embodiments of the disclosure;

FIG. 10 is an environmental back side perspective view of the deer feeder sound enhancer device in accordance with embodiments of the disclosure;

FIG. 11 is an environmental view of the deer feeder sound enhancer device showing the device attached to each of the legs of the deer feeder in accordance with embodiments of the disclosure.

### DETAILED DESCRIPTION OF THE INVENTION

Disclosed herein is an improved device and method of use directed to enhancing the sound of feed being distributed by deer feeders to increase the attraction of deer. The numerous innovative teachings of the present invention will be described with particular reference to several embodiments (by way of example, and not of limitation).

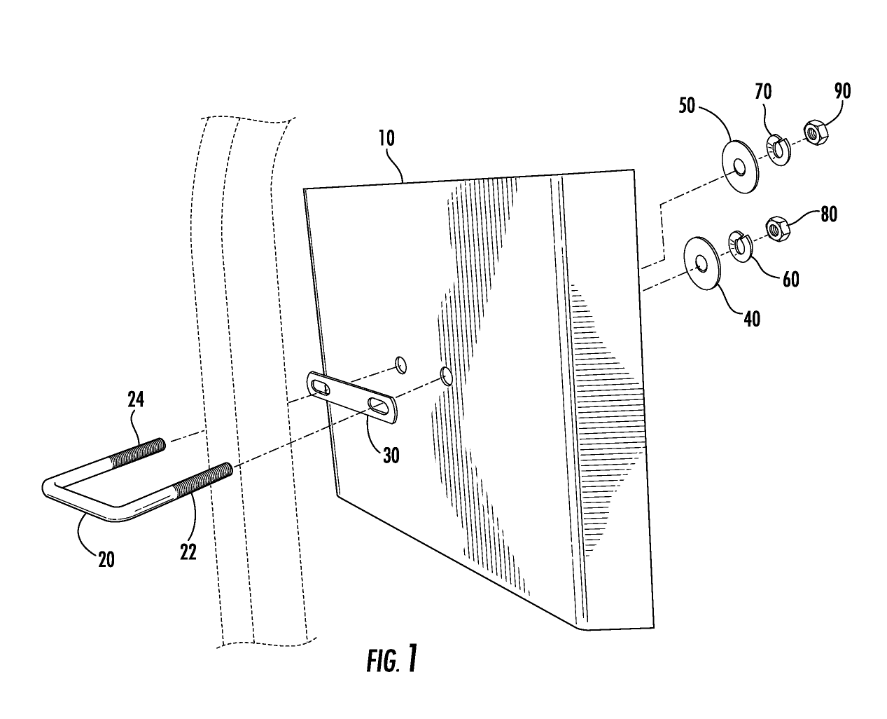

Reference is first made to FIG. 1, a back side exploded perspective view of the deer feeder sound enhancer device in accordance with embodiments of the disclosure. Illustrated in this figure are the elements that make up the deer feeder sound enhancer device. In one embodiment the device is comprised of a base element 10 and an attachment element 20, 30, 40, 50, 60, 70, 80, 90. The base element provides a surface that is hit or struck by the feed as the feed is being distributed in order to amplify the sound. That is, the base element in an embodiment, has a surface portion used to be hit or struck by the deer feed as the deer feed is being distributed that may be embodied by various shapes and sizes. The deer feed as it is being distributed hits the back of the base element before the deer feed hits the ground. When the deer feed hits or strikes the base element, a much louder sound is produced than when the deer feed just hits the deer feeder leg and then the ground. In these illustrations, the deer feed would hit the back side of the base element when the deer feed is being distributed by the deer feeder. By amplifying the sound, the deer feeder is made more effective by allowing the deer feeder to be heard at longer distances. This allows the attraction of more deer over a larger area. In another embodiment the base element is a plate 10. The plate may be made out of a rigid material such as but not limited to metals and polymers. In a preferred embodiment, the base element is made out of steel for better sound amplification. In an embodiment, the base element 10 is attached to the deer feeder by the attachment element 20, 30, 40, 50, 60, 70, 80, 90. The attachment element provides the means for attaching the base element 10. This may be achieved by the attachment element comprising various methods of attachment such as but not limited to an adhesive, string, straps, hooks, and Velcro. In yet another embodiment, the attachment element 20, 30, 40, 50, 60, 70, 80, 90 is comprised of a u bolt 20 with two threaded arms 22, 24, a flat strap 30, two flat washers 40, 50 (if needed), and two lock washers 60 , 70 (if needed), and two nuts 80, 90. In another embodiment, the base element 10 is attached to the deer feeder's leg as illustrated in FIG. 1 with the deer feeder's leg illustrated with environmental lines. This is achieved by having the deer feeder's leg placed between the u bolt's 20 arms with the base element 10 residing on the opposite side of the deer feeder's leg in relation to the u bolt 20 as illustrated in FIG. 1. The u bolt's 20 threaded arms 22, 24 are placed through the receiving holes in the base element 10 as depicted in FIG. 1. In yet another embodiment, a deer feeder sound enhancer device is attached to each leg of the deer feeder. That is if the deer feeder has three legs, there are three deer feeder sound enhancer devices with one attached to each leg. Washers 40, 50, 60, 70 are needed if the deer feeder's legs are too small and the washers 40, 50, 60, 70 are needed to secure a tight fit between the base element 10 and the deer feeder's leg. A tight fit is achieved when the base element 10 is not allowed to move with respect to the deer feeder's leg it is attached to.

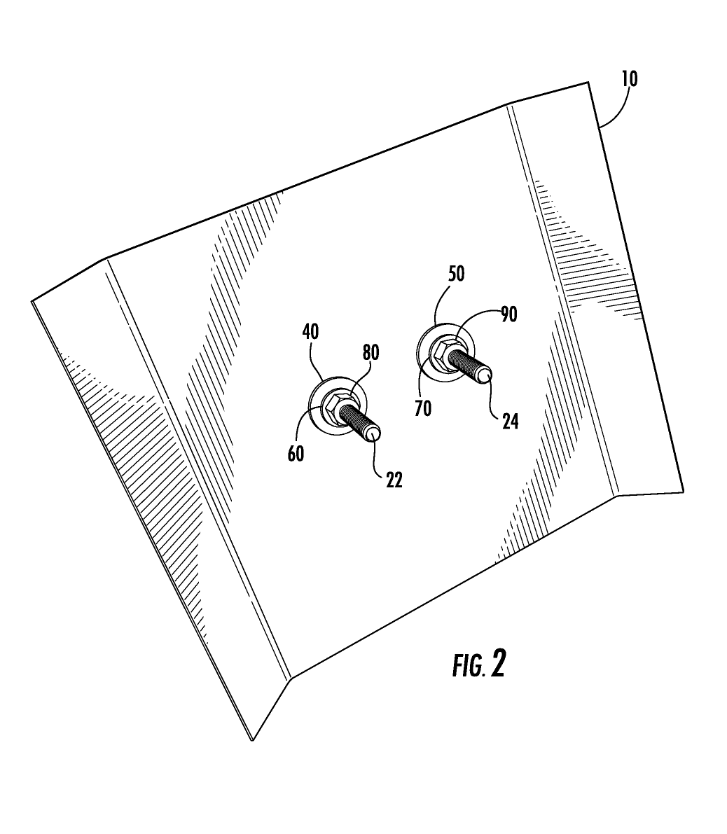

Reference is next made to FIG. 2, a front side perspective view of the deer feeder sound enhancer device in accordance with embodiments of the disclosure. Illustrated in this figure is the front portion of the deer feeder enhancer device showing the base element 10, the flat washers 40, 50, the lock washers 60, 70, and the threaded portion of the arms 22, 24 of the u bolt 20. FIG. 2 shows the deer feeder sound enhancer device in the assembled configuration.

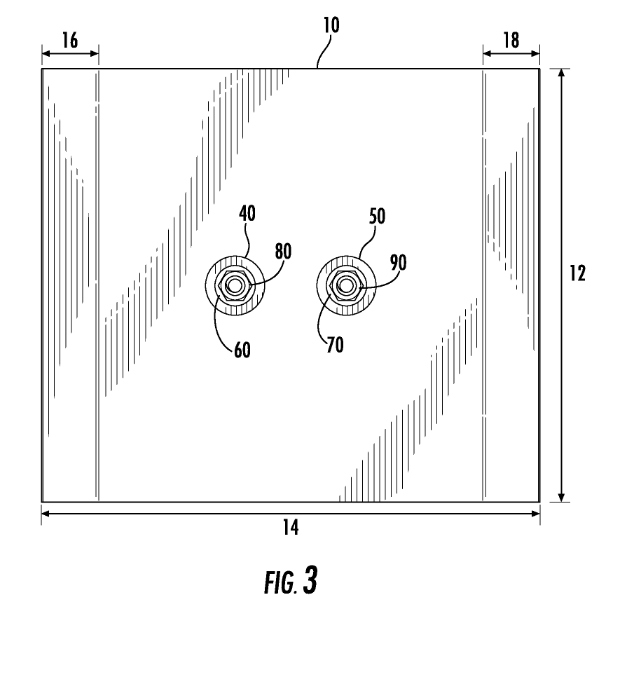

Reference is now made to FIG. 3, a front side view of the deer feeder sound enhancer device in accordance with embodiments of the disclosure. Illustrated in this figure is the front portion of the deer feeder enhancer device showing the base element 10, the flat washers 40, 50, the lock washers 60, 70, and the threaded portion of the arms 22, 24 of the u bolt 20. FIG. 3 shows the deer feeder sound enhancer device in the assembled configuration. In addition, in an embodiment, the width 14 of the base element 10 is ten (10) inches and the height 12 of the base element 10 is ten (10) inches. In another embodiment the base element 10 has angled or bent portions 16, 18 towards the front. These angled portions 16, 18 in an embodiment are each one and one half (1.5) inches wide on each side of the base element 10. In an embodiment, the base element 10 is made out of 16 gauge steel. In an embodiment, the base element has two three eighth (⅜) inch receiving holes for the u bolt's 20 threaded arms 22, 24 which are placed two and five sixteenth (2 5/16) inches apart. In an embodiment, the u bolt 20 is a two (2) inch inner diameter square u bolt 20 with a five sixteenth (5/16) inch diameter and three (3) inch legs with one and a half (1½) inch threads. In an embodiment, the flat strap is five eighth (⅝) inch wide with two three eighth (⅜) inch holes slotted two and five sixteenth (2 5/16) inches apart in alignment with the base element's 20 receiving holes for the u bolt's 20 threaded arms 22, 24.

Reference is next made to FIG. 4, a back side view of the deer feeder sound enhancer device in accordance with embodiments of the disclosure. Illustrated in this figure is the back portion of the deer feeder enhancer device showing the base element 10, the u bolt 20, and the flat strap 30. FIG. 4 shows the deer feeder sound enhancer device in the assembled configuration. In this illustration, the surface portion for striking by the deer feed is the back portion minus the angled portions on the left and right side of the base element.

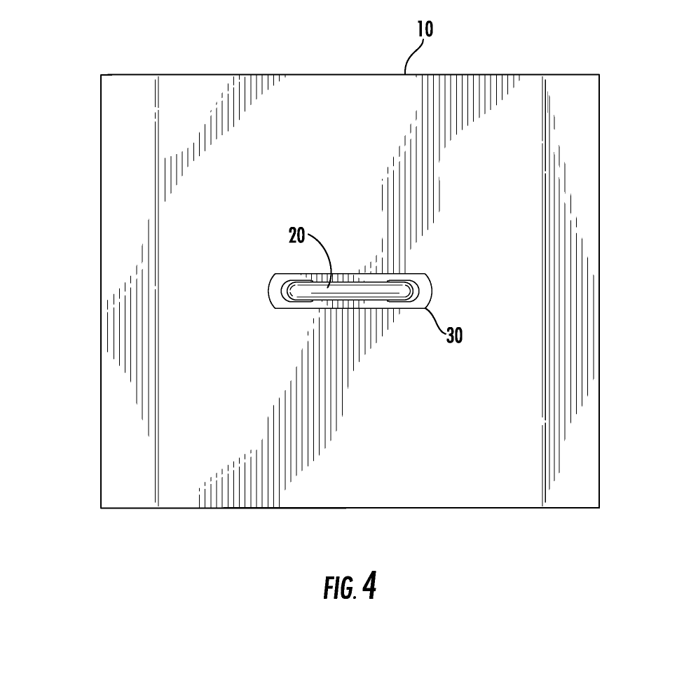

Reference is now made to FIG. 5, a bottom side view of the deer feeder sound enhancer device in accordance with embodiments of the disclosure. Illustrated in this figure is the bottom portion of the deer feeder enhancer device showing the base element 10, the u bolt 20 with two threaded arms 22, 24, a flat strap 30, two flat washers 40, 50, two lock washers 60 , 70, and two nuts 80, 90. Also shown in this figure are the angled portions 16, 18 of the base element 10 each having an angle θ. In an embodiment, angle θ is forty-five (45) degrees. FIG. 5 shows the deer feeder sound enhancer device in the assembled configuration. These angled portions help amplify the sound of the deer feed hitting the base element.

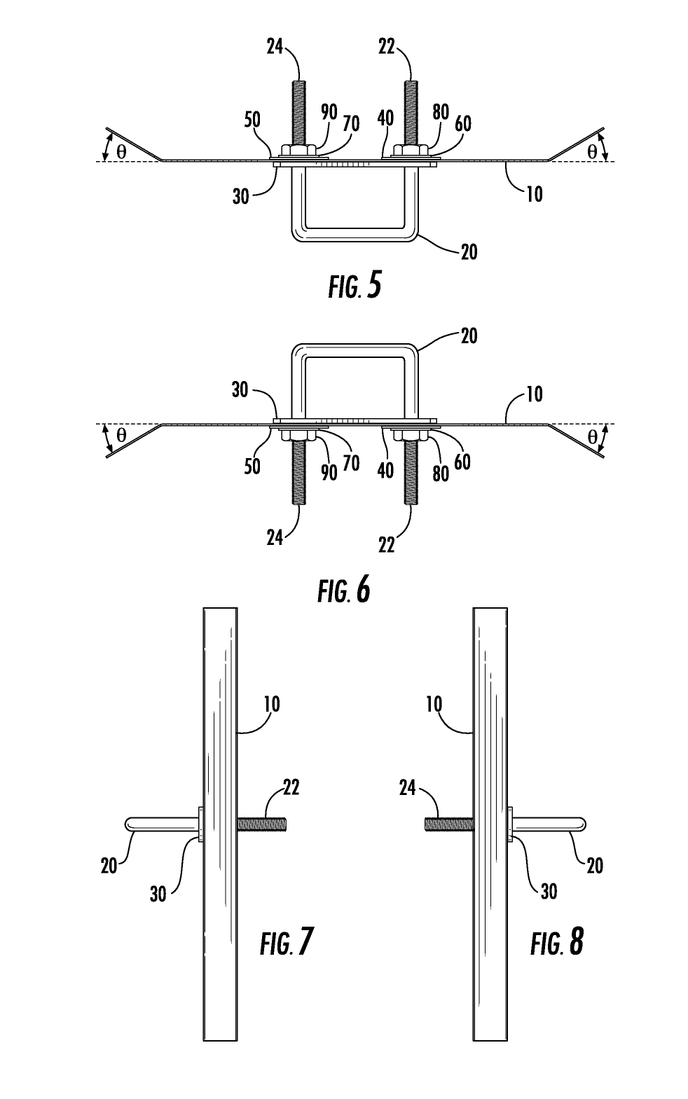

Reference is next made to FIG. 6, a top side view of the deer feeder sound enhancer device in accordance with embodiments of the disclosure. Illustrated in this figure is the top portion of the deer feeder enhancer device showing the base element 10, the u bolt 20 with two threaded arms 22, 24, a flat strap 30, two flat washers 40, 50, two lock washers 60 , 70, and two nuts 80, 90. Also shown in this figure are the angled portions 16, 18 of the base element 10 each having an angle θ. In an embodiment, angle θ is forty-five (45) degrees. However, this angle may be from one degree to 89 degrees with a preferred range of thirty (30) to sixty (60) degrees. FIG. 6 shows the deer feeder sound enhancer device in the assembled configuration.

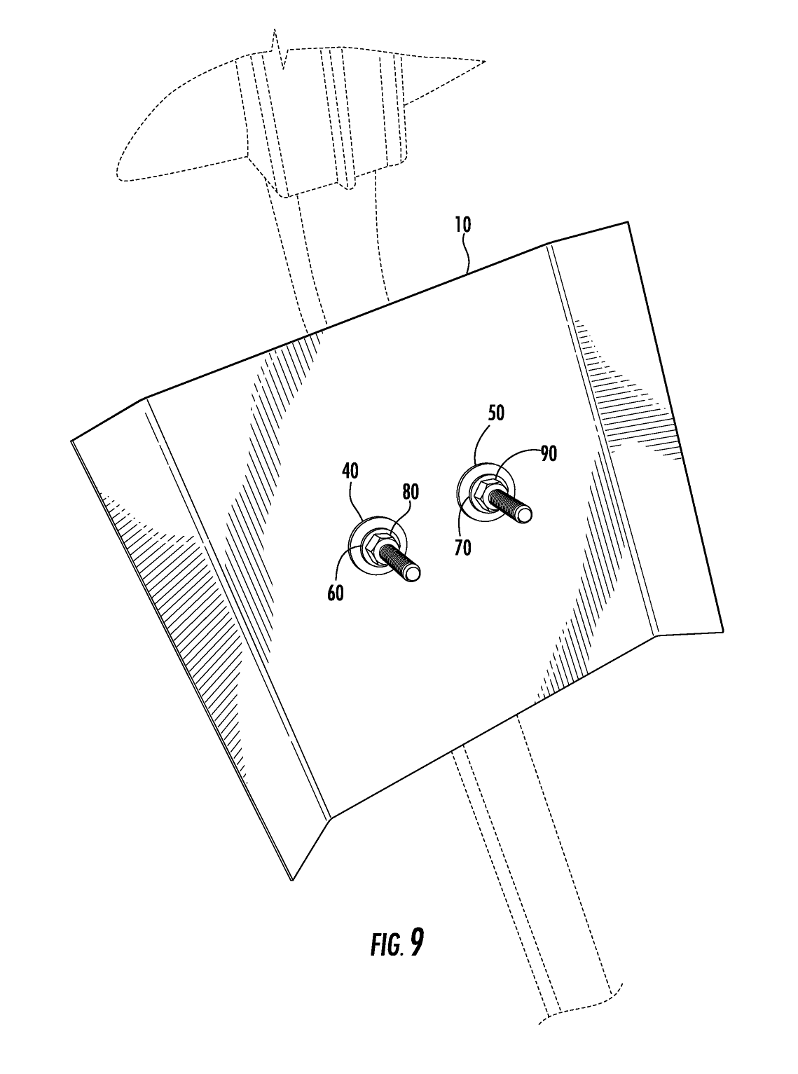

Reference is now made to FIG. 7, a left side view of the deer feeder sound enhancer device in accordance with embodiments of the disclosure. Illustrated in this figure is the left portion of the deer feeder sound enhancer device showing the base element 10, the u bolt 20 with the threaded portion 22, and the flat strap 30. FIG. 7 shows the deer feeder sound enhancer device in the assembled configuration. Also shown in this figure are the angled portions 16, 18 of the base element 10 each having an angle θ. In an embodiment, angle θ is forty-five (45) degrees.

Reference is next made to FIG. 8, a right side view of the deer feeder sound enhancer device in accordance with embodiments of the disclosure. Illustrated in this figure is the right portion of the deer feeder sound enhancer device showing the base element 10, the u bolt 20 with the threaded portion 24, and the flat strap 30. FIG. 8 shows the deer feeder sound enhancer device in the assembled configuration. Also shown in this figure are the angled portions 16, 18 of the base element 10 each having an angle θ. In an embodiment, angle θ is forty-five (45) degrees.

Reference is now made to FIG. 9, an environmental front side perspective view of the deer feeder sound enhancer device in accordance with embodiments of the disclosure. Illustrated in this figure is the front portion of the deer feeder enhancer device showing the base element 10, the flat washers 40, 50, the lock washers 60, 70, and the threaded portion of the arms 22, 24 of the u bolt 20. FIG. 9 shows the deer feeder sound enhancer device in the assembled configuration attached to the deer feeder's leg.

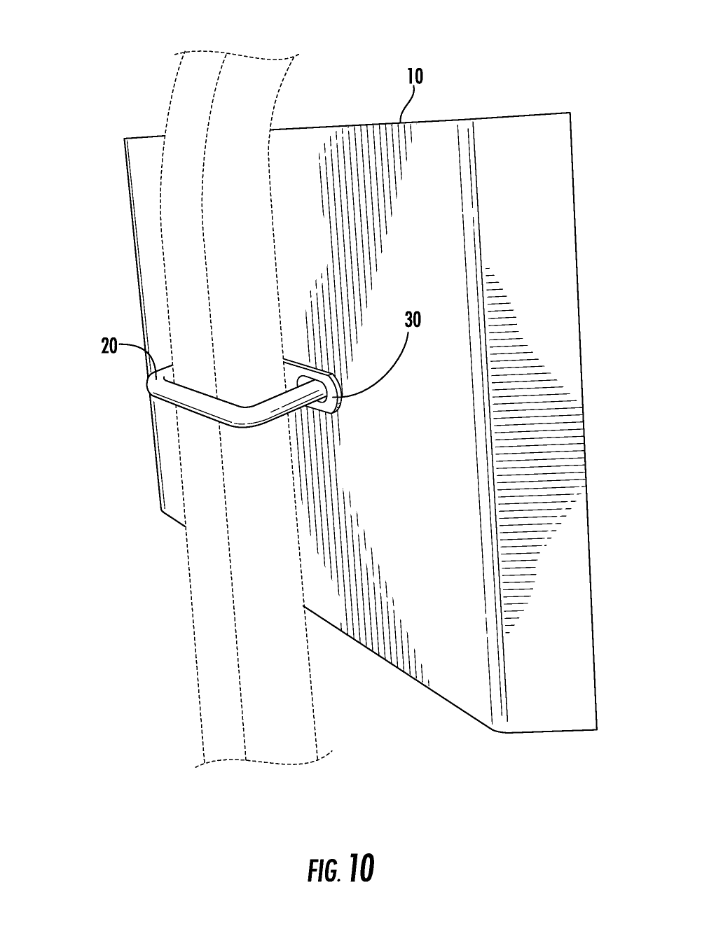

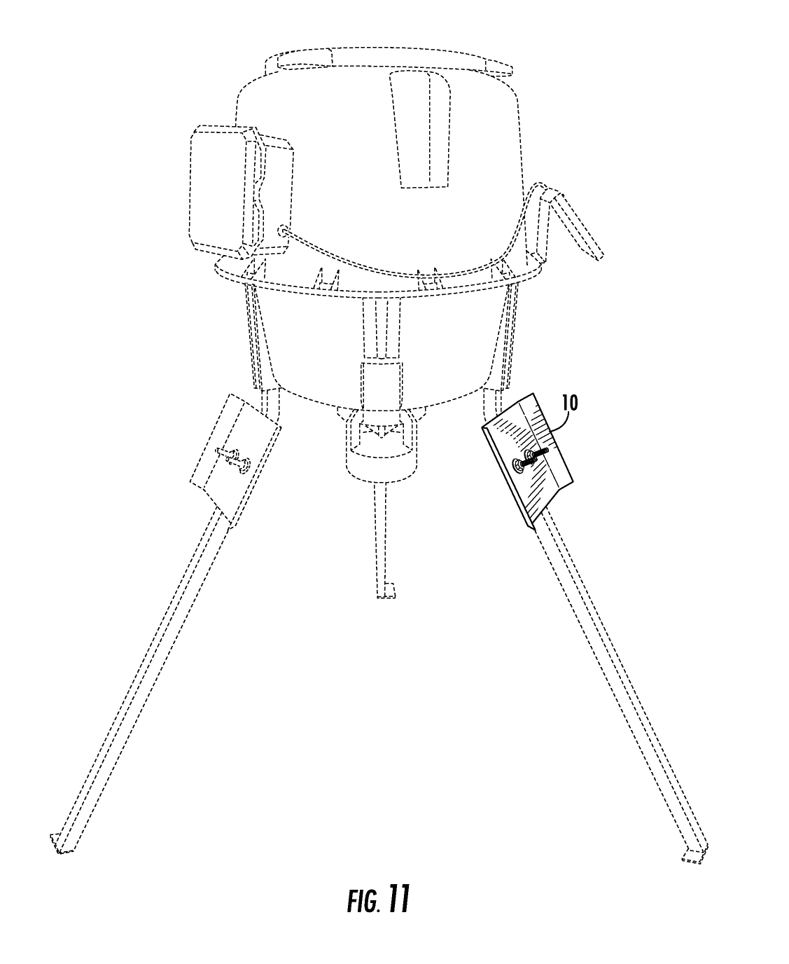

Reference is next made to FIG. 10, an environmental back side perspective view of the deer feeder sound enhancer device in accordance with embodiments of the disclosure. Illustrated in this figure is the back portion of the deer feeder enhancer device showing the base element 10, the u bolt 20, and the flat strap 30. FIG. 10 shows the deer feeder sound enhancer device in the assembled configuration attached to the deer feeder's leg.

Reference is lastly made to FIG. 11, an environmental view of the deer feeder sound enhancer device showing the device attached to each of the legs of the deer feeder in accordance with embodiments of the disclosure. Illustrated in this figure is the device attached to the deer feeder. The position of the device is at a location on the deer feeder's leg such that when the feed is being distributed, the feed hits the back portion of the base element 10.

In brief, the device and method of use is directed to a device directed to amplifying the sound of feed being distributed by deer feeders to increase the attraction of deer.

The disclosed device and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using this device for enhancing the sound of not just deer feeders, but animal feeders in general. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A deer feeder sound enhancer device comprising:
a base element having a surface portion wherein said surface portion is used as a striking surface for the deer feed as said deer feed is being distributed from a deer feeder;
and an attachment element that provides the means for attaching said base element to said deer feeder.

2. The device of claim 1, wherein said base element is a plate.

3. The device of claim 2, wherein said base element is a square plate.

4. The device of claim 1, wherein said base element is further comprised of at least one angled portion.

5. The device of claim 1, wherein said base element is further comprised of two angled portions.

6. The device of claim 5, wherein said two angled portions are on opposing sides of said base element.

7. The device of claim 6, wherein said two angled portions are on the left and right side of said base element.

8. The device of claim 4, wherein said angle portion has an angle of one to eighty nine degrees.

9. The device of claim 4, wherein said angle portion has an angle of thirty to sixty degrees.

10. The device of claim 4, wherein said angle portion has an angle of forty five degrees.

11. The device of claim 1, wherein said base element is further comprised of at least one receiving hole.

12. The device of claim 1, wherein said base element is further comprised of two receiving holes.

13. The device of claim 12, wherein said receiving holes are placed two and five sixteenth (2 5/16) inches apart and centered on said base element.

14. The device of claim 1, wherein said attachment element is an adhesive.

15. The device of claim 1, wherein said attachment element is a string or strap.

16. The device of claim 1, wherein said attachment element is a hook or Velcro.

17. The device of claim 1, wherein said attachment element is comprised of a u bolt with threaded arms, a flat strap, and two nuts for each said threaded arm.

18. The device of claim 17, wherein said attachment element is further comprised of at least two flat washers.

19. The device of claim 18, wherein said attachment element is further comprised of at least two two lock washers.

20. A deer feeder sound enhancer device comprising:
a base element having a surface portion wherein said surface portion is used as a striking surface for the deer feed as said deer feed is being distributed from a deer feeder;
and an attachment element that provides the means for attaching said base element to said deer feeder;
and wherein said base element is further comprised of at least two receiving holes placed two and five sixteenth (2 5/16) inches apart and centered on said base element for receiving said attachment element;
and wherein said base element is a square plate;
and wherein said base element is further comprised of two angled portions on the left and right side of said base element running from the top to the bottom of said base element and said angled portion having an angle between thirty and sixty degrees;
and wherein said attachment element is comprised of a u bolt with threaded arms, a flat strap, and two nuts for each said threaded arm;
